(19) United States
(12) Patent Application Publication
(10) Pub. No.: US 2014/0349802 A1
(43) Pub. Date: Nov. 27, 2014

(54) PINION SHAFT BEARING ARRANGEMENT

(71) Applicants: Frank Steiner, Rauenstein (DE); Ramon Jurjanz, Erlangen (DE); Tomas Smetana, Herzogenaurach (DE)

(72) Inventors: Frank Steiner, Rauenstein (DE); Ramon Jurjanz, Erlangen (DE); Tomas Smetana, Herzogenaurach (DE)

(73) Assignee: SCHAEFFLER TECHNOLOGIES AG & CO. KG, Herzogenaurach (DE)

(21) Appl. No.: 14/342,089

(22) PCT Filed: Aug. 13, 2012
(86) PCT No.: PCT/EP2012/065808

§ 371 Date: Jun. 24, 2014

(30) Foreign Application Priority Data
Sep. 1, 2011 (DE) 102011082014.0

(51) Int. Cl. F16C 33/66

(52) U.S. Cl. CPC F16C 33/6637
USPC 475/150; 384/462

(57) ABSTRACT

A pinion shaft bearing arrangement including a pinion shaft, which is mounted by means of at least two rolling bearings in a pinion shaft housing, the pinion shaft bearing housing being a bearing cartridge, having running surface formed on the inner circumference for the rolling elements of the rolling bearings. The pinion shaft housing is sealed in the direction of the pinion shaft by means of a sealing element, and a first lubricant channel is provided in the region between the rolling bearings and a second lubricant channel is provided in the region in front of the sealing element.

### CROSS-REFERENCE TO RELATED APPLICATIONS

The present application is the U.S. national stage application pursuant to 35 U.S.C. §371 of International Application No. PCT/EP2012/065808, filed Aug. 13, 2012, which application claims priority of German Application No. 102011082014.0, filed Sep. 1, 2011.

### FIELD OF THE INVENTION

The invention relates to a pinion shaft bearing arrangement including a pinion shaft, which is mounted in a pinion shaft housing by means of at least two roller bearings, where the pinion shaft bearing housing is a bearing assembly with bearing surfaces, formed on the inner periphery, for the rolling elements of the roller bearings.

### BACKGROUND OF THE INVENTION

Such a pinion shaft bearing arrangement is used, for example, as a drive unit of a differential. In this case two drivable axles of for example, a motor vehicle are driven by the drive unit. Hence, the pinion shaft bearing arrangement is used for the final drive. For this purpose, the pinion shaft bearing arrangement is coupled, as well-known, directly or indirectly by way of an intermediate transmission to a drive unit, such as an internal combustion engine or an electric motor.

Such a pinion shaft bearing arrangement is known, for example, from the German Patent No. 37 05 607 A1. In this case, the pinion shaft bearing arrangement includes not only the pinion shaft that bears the pinion, for example, a toothed bevel gear, but also a pinion shaft housing, in which the pinion shaft is rotatably mounted by means of two roller bearings, tapered roller bearings that are usually tightened against each other. Each roller bearing has an inner ring, seated on the pinion shaft, The outer ball races are formed by the pinion shaft housing itself, which for this purpose is formed as a bearing assembly, so that no separate outer rings are provided, In the case of the pinion shaft bearing arrangement known from the prior art German Patent No. 37 065 607 A1 a separate sealing sleeve is flange-mounted on the pinion shaft housing on the side facing away from the pinion.

The sealing sleeve seals tightly, on the one hand, in the direction of the pinion shaft housing by means of a sealing element and, on the other hand, in the direction of the pinion shaft itself, respectively, a coupling sleeve, which is slid over said pinion shaft, by means of an additional sealing element, namely a lip seal. An additional sealing element seats tightly toward the housing of the differential. in order to make sure that the pinion shaft bearings are lubricated, a collecting groove is provided in the differential housing. When the differential gears rotate, the lubricant collects in said collecting groove, from which the lubricant flows into the area between to the two roller bearings by way of a duct, which initially extends radially in the differential housing and then extends radially in the pinion shaft housing. From this area between the two roller bearings the lubricant passes into the volume area, which is closed off by means of the flange-mounted sealing sleeve, behind the pinion shaft housing and flows back into the differential housing by way of a discharge duct, which is axially open at the rear section of the pinion shaft housing and which runs through and issues radially from the pinion shaft housing. The discharge duct in turn empties into a section of the duct that continues its course through the differential housing. The design of this pinion shaft bearing arrangement is very complex, in particular with respect to the lubrication,

### BRIEF SUMMARY OF THE INVENTION

The object of the present invention is to provide a pinion shaft bearing arrangement that is simplified compared to the above described state of the art.

In order to solve this problem, the invention provides that the pinion shaft housing is tightly sealed in the direction of the pinion shaft by means of a sealing element and that a first lubricant duct extends into the region between the roller bearings; and a second lubricant duct extends into the region in front of the sealing element.

The pinion shaft housing is sealed directly by means of a sealing element in the direction of the pinion shaft, be it either the shaft itself or a shaft component attached to said shaft. That is, the pinion shaft housing is extended, when viewed from the direction of the differential, beyond the rear roller bearings to such an extent that it is possible to integrate a sealing element in this region. The use of an additional component, such as a sealing sleeve or the like, which is arranged on the pinion shaft housing, is not necessary, because both the radial definition and axial sealing are provided solely by means of the one-piece pinion shaft housing in the form of the bearing assembly.

Lubrication is provided by means of two lubricant ducts, where in this case a first lubricant duct also extends into the region between the two roller bearings. however, the second duct, which carries the lubricant away, extends directly into the region between the rear (when viewed from the direction of the differential) roller bearing and the sealing element, which is located downstream of said roller bearing and where the lubricant is received. This means that consequently the entire routing of the lubricant is accomplished exclusively in the self-supporting bearing assembly; and even more advantageous is the fact that additional components are not required for the pinion shaft bearing arrangement.

In an embodiment, both lubricant ducts open out on the end face of the pinion shaft housing. That is, the lubricant is supplied directly at the end face. The same applies to the return flow into the differential housing. Thus, the lubricating oil enters into the feed duct in the region of the front side of the housing. Such an arrangement is easily possible, since sufficient lubricating oil is circulated in the housing when the differential is running, so that an adequate amount can always enter. Even the return flows again directly into the differential housing from the front side.

However, as an alternative, it is also conceivable that the first duct, i.e., the feed duct, opens out on the peripheral surface; and the second duct opens out on the front side of the pinion shaft housing. Therefore, the first duct can open out radially or may have at least one radially emptying opening section. However, the second return duct ends in any event on the front side. However, the actual configuration, respectively routing of the ducts, depends ultimately on how the pinion shaft housing, i.e., the bearing assembly, is attached to the downstream component, for example, the differential. Hence, it depends on whether a small amount of radial installation space for forming a radially emptying feed duct is still provided or whether this feed duct is supposed to open out primarily on the front side.

The lubricant bores are arranged circumferentially in such a way that they are offset by at least 45°, preferably by 90°, relative to each other; and, of course, a greater circumferential offset is conceivable, depending on the respective installation situation.

The sealing element itself, by means of which the pinion shaft housing is tightly sealed toward the pinion shaft, is for example, a radial shaft sealing ring. This radial shaft sealing ring can seal either directly toward the pinion shaft or toward a tightening nut, by means of which the two roller bearings are prestressed. In this case the roller bearings, for example, tapered roller bearings, can be tightened either directly against the pinion, i.e., for example, the bevel gear. However, as an alternative, an adjusting washer can also be inserted in this area.

The self-supporting bearing assembly is designed as a one-piece component. That is, the entire pinion shaft housing is defined only by the one component. For easy mounting it is expedient to form a radially extending mounting flange, by means of which the pinion shaft housing is screwed, for example, to the differential housing. From this mounting flange, a relatively short dimensioned axial section of the housing can still extend in the direction of the differential housing and can extend a ways into said differential housing, so that by implication it is also possible to provide, for example, a radially open inlet duct in this region. In any case, there is no need to provide any collecting grooves or ducts that extend into the differential housing itself, because the oil feed system, respectively the ducts run only in the pinion shaft housing, i.e., the bearing assembly, and communicate, for example, with the downstream differential.

In an embodiment, a sensor element, in particular, a resolver, which interacts with the pinion shaft, can be arranged externally on the pinion shaft housing. The embodiment as a one-piece component makes it possible to provide externally a matching recess or the like, in which a sensor element can be arranged, because there is no need whatsoever to provide on the pinion shaft housing some kind of attachment point for a sealing sleeve and the like that would be restrictive in some way for the arrangement of an external component. This means that a radial recess, in which a sensor element can be used, for example, can be formed without difficulty.

In addition to the pinion shaft bearing arrangement itself, the invention also relates to a drive system, having an electric motor with an outputting hollow motor shaft, a pinion shaft bearing arrangement of the type described above as well as a differential, which is driven by means of the pinion shaft, which is driven by the electric motor. In this case, the pinion shaft is arranged concentrically in the motor shaft; and the bearing assembly is tightly sealed and connected to a differential housing, enclosing the differential, by means of a sealing element.

Such a drive system is used, for example, as a drive unit of a motor vehicle. it serves as a drive in electric vehicles or hybrid vehicles. The electric motor can drive the pinion shaft directly or by means of a transmission, which is downstream of said electric motor or is coupled to the pinion shaft, which in turn drives the differential, which then branches out to the driven axles. In the drive system according to the invention, the pinion shaft is now accommodated in the interior of the hollow motor shaft and can be rotated separately relative to the motor shaft. In this case the pinion shaft is moved, as stated, by means of the electric motor, the motion of which is coupled to said pinion shaft. The pinion shaft itself is coupled directly to the differential, That is, no transmission is interposed. Said transmission can be arranged, if such a transmission is to be provided, on the other side of the electric motor, so that the electric motor is positioned between the differential and the transmission.

The pinion shaft housing of the pinion shaft bearing arrangement is supported directly by the differential housing, which accommodates the differential, respectively its corresponding components. That is, the pinion shaft housing is attached to the differential housing. This means that in this case a closed module is produced that is closed outwards, respectively toward the electric motor by means of the other two housings, i.e., the differential housing and the pinion shaft housing, both housing being connected to each other, As a result of this perfect seal, which is achieved by such an arrangement, the electric motor is consequently totally in the “dry” area. This means that there is absolutely no flow of lubricant into, respectively through the electric motor, because the differential housing and the pinion shaft housing completely define and limit the lubricant space required to lubricate the differential as well as the pinion shaft bearing. For this purpose suitable sealing elements, namely, on the one hand, the sealing element in the pinion shaft housing, where the sealing element seals toward the pinion shaft, as well as an additional sealing element, for example, an O-ring, which tightly seals the connecting interface between the pinion shaft housing and the differential housing, are provided.

### BRIEF DESCRIPTION OF THE DRAWINGS

One embodiment of the invention is shown in the drawings and described in detail below. The drawings show in:

FIG. 1 is a schematic sketch elucidating the principle of a drive system according to the invention;

FIG. 2 is an enlarged detail view of the region between the electric motor and the differential with the pinion shaft bearing arrangement inserted in-between;

FIG. 3 is a 90° sectional view of the pinion shaft bearing arrangement; FIG. 4 is a longitudinal sectional view of the pinion shaft bearing arrangement; and,

FIG. 5 is a perspective view of the pinion shaft bearing arrangement.

### DETAILED DESCRIPTION OF THE INVENTION

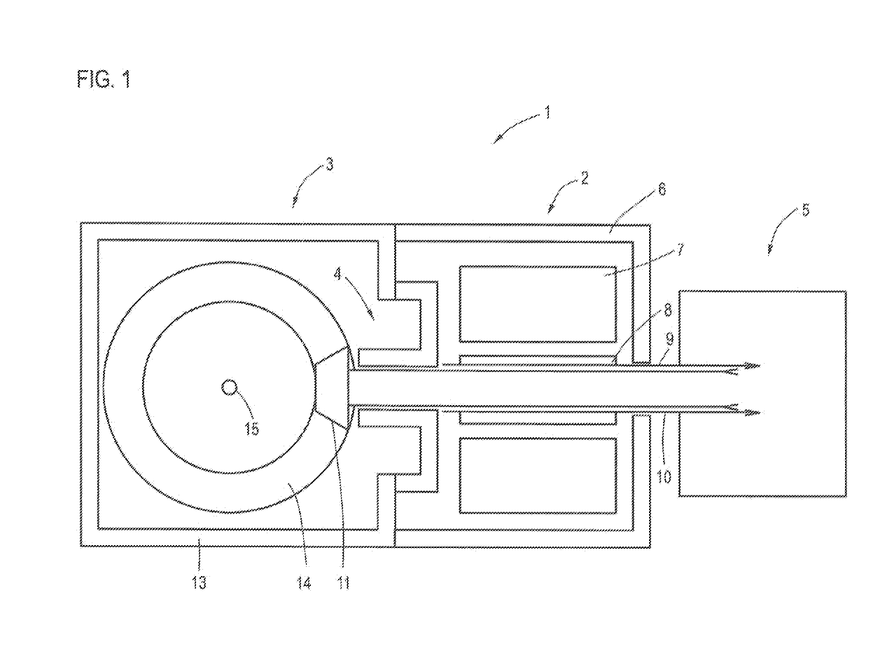

FIG. 1 is a schematic sketch elucidating the principle of an inventive drive system 1, having an electric motor 2, a differential 3, a pinion shaft bearing arrangement 4 and a transmission 5 that may or may not be shown.

Electric motor 2 includes motor housing 6, stator 7 and rotor 8, which is connected to hollow motor shaft 9, which is rotated, therefore, by means of rotor 8 during normal operation. Motor shaft 9 extends into transmission 5, for example, a shiftable transmission having a plurality of gear stages.

Pinion shaft 10 of pinion shaft bearing arrangement 4 is driven by means of the transmission; and the pinion shaft (see FIG. 1) runs through entire hollow motor shaft 9. That is, it comes from transmission 5 and extends as far as into differential 3. Pinion shaft bearing arrangement 4 includes not only pinion shaft 10 with the pinion, which in this case is configured as toothed bevel gear 11, but also pinion shaft housing 12, in which pinion shaft 10 is mounted by means of bearings, which are not shown in detail. This feature will be discussed in detail

Finally, differential 3 includes differential housing 13, in which, of course, not only central differential drive gear 14, with which bevel gear 11 meshes, but also other additional components, in particular, outputting drive shafts 15 and the like are arranged.

During normal operation, when stator 7 is supplied with current, rotor 8 and with it motor shaft 9 are rotated. The rotation of motor shaft 9 is given via transmission 5 translated to pinion shaft 10, by means of which the differential operates due to bevel gear 11 meshing with differential drive gear 14; and output shafts 15, which lead to corresponding drive axles, are rotated.

It is clear that the result is a design, where electric motor 2 is also arranged to between differential 3 and transmission 5, which, of course, can also be screwed directly to motor housing 6. This means that the output end of motor shaft 9 in the illustrated embodiment runs to the right into transmission 5, whereas pinion shaft 10, which is driven by means of the transmission, runs through hollow motor shaft 9 back in the opposite direction into differential 3, which may be found on the other side of electric motor 2.

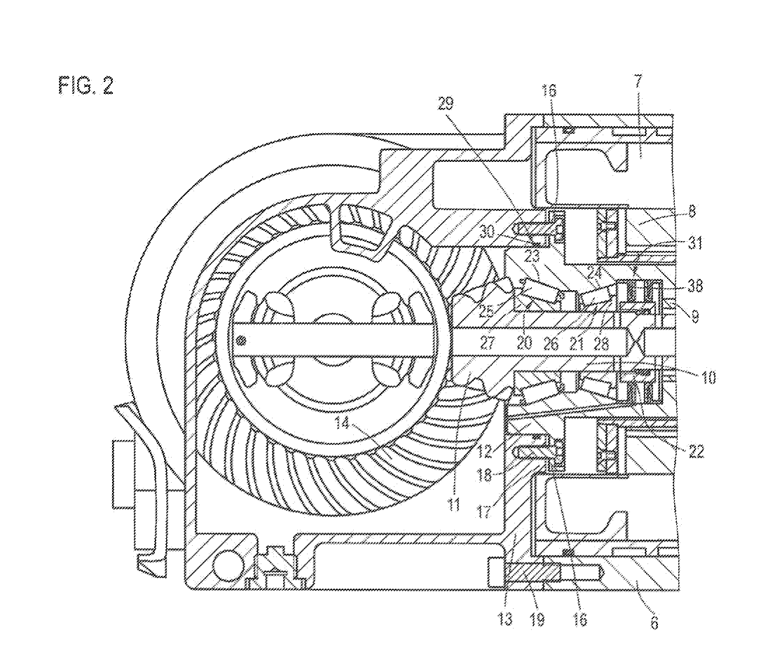

As shown in FIG. 1 and FIG. 2, pinion shaft housing 12 (which is shown in FIG. 1 only as a simple sketch) is supported on differential housing 13, respectively attached to the housing. it is clear from FIG. 2, which depicts a more concrete embodiment, that for this purpose pinion shaft housing 12 has radial flange 16, which in the installed position rests axially against corresponding mounting section 17 of the differential housing 13 and is screwed there by means of connecting screws 18. Differential housing 13 in turn is supported on motor housing 6.

For this purpose there are also mounting screws 19 that connect differential housing 13 to motor housing 6. Therefore, the whole drive system is defined externally, with respect to electric motor 2 and differential 3, by motor housing 6 and differential housing 13.

A key component is, as described above, pinion shaft bearing arrangement 4. Pinion shaft 10 is rotatably mounted in pinion shaft housing 12 by means of two roller bearings 20, 21. The roller bearings 20, 21 are axially secured relative to each other by means of tightening nut 22, which is screwed on pinion shaft 10. According to FIG. 2, the roller bearings are tightened against bevel gear 11, but can also be tightened against an adjusting washer, which may be found between them.

Pinion shaft housing 12 is designed as a one-piece bearing assembly, in which bearing surfaces 23, 24 for tapered rollers 25, 26 of two roller bearings 20, 21 are formed. This means that, save for two inner rings 27, 28, there are no separate outer rings that have to be integrated. Rather, the roller bearing receives the self-supporting bearing assembly.

Pinion shaft bearing arrangement 4 is tightly sealed in the direction of differential housing 13 by means of first sealing element 29 in the form of an O-ring. O-ring 30 is located in a corresponding receiving groove on the inner periphery of mounting section 17 of differential housing 13; and it seals radially in the direction of the outer periphery of pinion shaft housing 12 having a leading annular collar that engages with differential housing 13. This means that a first sealing level is achieved in this region. A second sealing level is achieved by means of second sealing element 31 in the form of radial shaft sealing ring 38, which seals between pinion shaft housing 12 and pinion shaft 10, respectively, tightening nut 22, which is securely mounted on pinion shaft 10. That is, the result of this arrangement is a closed and sealed space that is formed, respectively defined, by the interior of differential housing 13 and pinion shaft housing 12.

This seal is necessary to ensure that entire electric motor 2 is arranged completely in the “dry” area, thus ensuring that no lubricating fluid, which is in the interior of differential housing 13, can pass into the region of electric motor 2.

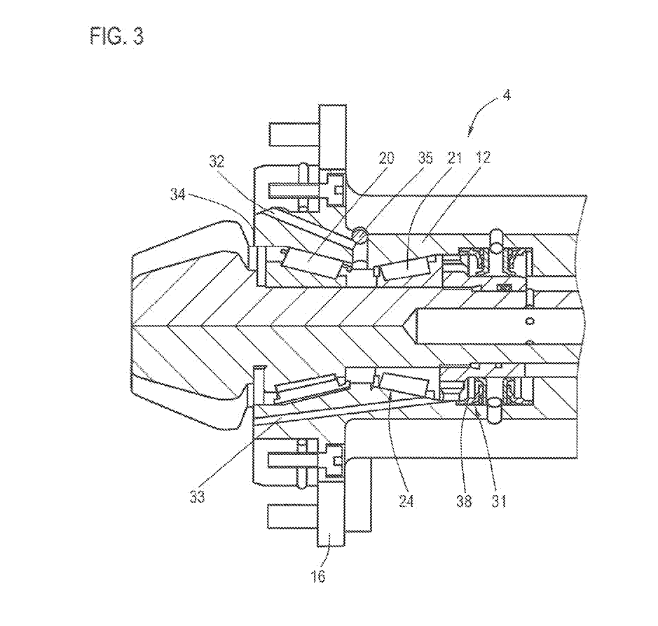

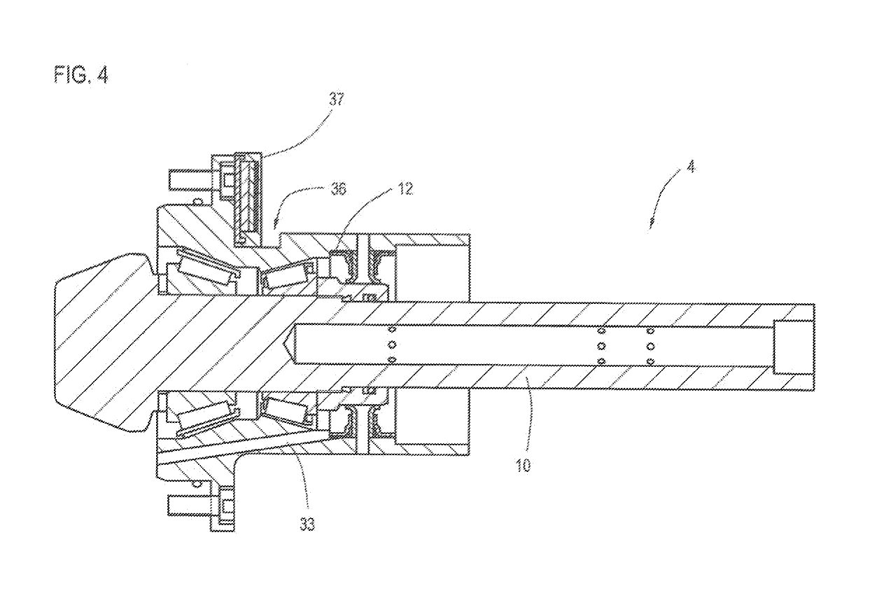

In order to ensure that not only differential 3 itself, but also roller bearing of pinion shaft housing 12 is lubricated by means of the lubricating fluid, for example, an oil, which may be found in differential housing 13, two ducts, namely feed duct 32 and discharge duct 33, are formed in pinion shaft housing 12 (see FIG. 3). In the illustrated example, feed duct 32 opens out close to end face 34 of pinion shaft housing 12. Therefore, the feed duct has an opening region on the front as well as a radial opening region, so that oil that is necessarily splashed about, respectively is conveyed, upon rotation of the differential components, can pass into feed duct 32. Feed duct is designed in such a way that it extends obliquely in the direction of pinion shaft 10 and angles off toward the end. At the same time, this area is closed outwards by means of ball 35. Feed duct 32 empties (see FIG. 3) in the region between roller bearings 20, 21, so that consequently any lubricating oil that is supplied in this way is introduced precisely into this region, in which it is needed.

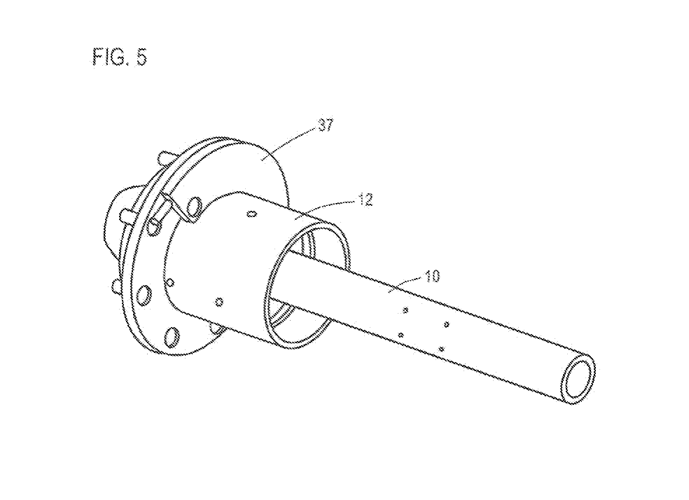

Discharge duct 33, which opens out on end face 34 and is circumferentially offset preferably by 90° relative to feed duct 32, runs as far as up into the region between second sealing element 31, i.e., radial shaft sealing ring 38 and adjacent roller bearing 24. In the assembled situation, discharge duct 33 extends in such a way that it extends virtually into the deepest region of pinion shaft housing 12, where the lubricating oil collects, so that the lubricating oil can be discharged there. Hence, the lubricating oil is removed from a region “behind” second roller bearing 24. Such an arrangement ensures a reliable lubrication of the pinion shaft bearing. At the same time it is ruled out that the lubricating oil can pass into the region of the electric motor, because the conditions for a perfect seal toward the electric motor side have been met, on the one hand, statically by means of O-ring 30 on the axial flange of the bearing assembly and, on the other hand, dynamically by means of radial shaft sealing ring 38. Since it involves here a longitudinal sectional view, only discharge duct 33 can be seen. However, FIG. 4 shows recess 36, which is formed on the outside of pinion shaft housing 12. The recess has a sensor element 37, in the illustrated example, a resolver, hence, a rotary encoder. Rotary encoder interacts in a well-known manner with pinion shaft 10 and detects the rotation of the pinion shaft, so that corresponding signals can be directly picked off in this area. The resolver, which is also shown in the perspective view according to FIG. 5, extends, for example, by approximately 90°. Therefore, the resolver is a curved component which can be easily integrated, even though relatively little installation space is provided. Another advantage is that the resolver, which is disposed outside pinion shaft housing 12, is also arranged in the dry area toward electric motor 2, because, as described above, this region is completely sealed by means of sealing element 29 and 31.

As described above, transmission 5 is optional in this respect. If it is provided, then it may also be arranged with its housing directly on motor housing 6. The transmission has its own lubrication. This means that no lubricant ducts extend from differential 3 to transmission 5. In this case, the lubricant ducts would have to be routed necessarily through electric motor 2. If no transmission 5 is available, it would be necessary to provide a direct meshing between motor shaft 9 and pinion shaft 10, and this meshing would then be provided inside motor housing 6.

### List of Reference Numerals

1 drive device

2 electric motor

3 differential

4 pinion shaft bearing arrangement

5 transmission

6 motor housing

7 stator

8 rotor

9 motor shaft

10 pinion shaft

11 bevel gear

12 pinion shaft housing

13 differential housing

14 differential drive gear

15 output shafts

16 radial flange

17 mounting section

18 connecting screws

19 mounting screws

20 roller bearing

21 roller bearing

22 tightening nut

23 bearing surfaces

24 bearing surfaces

25 tapered rollers

26 tapered rollers

27 inner ring

28 inner ring

29 sealing element

30 O-ring

31 sealing element

32 feed duet

33 discharge duct

34 end face

35 ball

36 recess

37 sensor element

38 radial shaft seal

What is claimed is:

1-10. (canceled)

11. A pinion shaft bearing arrangement, comprising:
a pinion shaft housing;
at least two roller bearings, wherein each of the at least two roller bearings includes at least one rolling element;
a pinion shaft, which is mounted in the pinion shaft housing by means of the at least two roller bearings, wherein the pinion shaft bearing housing is a bearing assembly with bearing surfaces, formed on the inner periphery, for the rolling elements of the at least two roller bearings;
a sealing element, wherein the pinion shaft housing tightly seals towards the pinion shaft by means of the sealing element;
a first lubricant duct, wherein the first lubricant duct extends into the region between the at least two roller bearings; and,
a second lubricant duct, where the second lubricant duct extends into the region in front of the sealing element.

12. The pinion shaft bearing arrangement as recited in claim 11, wherein the pinion shaft housing comprises an end face and the first and second lubricant ducts open out on the end face of the pinion shaft housing, or that the first lubricant duct opens out on the peripheral surface, and the second lubricant duct opens out on the front side of the pinion shaft housing.

13. The pinion shaft bearing arrangement as recited in claim 11, wherein the first and second lubricant ducts extend circumferentially in such a way that they are offset by at least 45°.

14. The pinion shaft bearing arrangement as recited in claim 11, wherein the sealing element is a radial shaft sealing ring.

15. The pinion shaft bearing arrangement as recited in claim 14, wherein the radial shaft sealing ring seals directly toward the pinion shaft or toward a tightening nut, by means of which the at least two roller bearings are prestressed.

16. The pinion shaft bearing arrangement as recited in claim 11, wherein the roller bearings are tapered roller bearings.

17. The pinion shaft bearing arrangement as recited in claim 11, wherein a radially extending mounting flange is formed on the bearing assembly.

18. The pinion shaft bearing arrangement as recited in claim 11, wherein a sensor element, which interacts with the pinion shaft, is arranged externally on the pinion shaft housing.

19. The pinion shaft bearing arrangement as recited in claim 18, wherein a recess, into which the sensor element is inserted, is provided on the pinion shaft housing.

20. A drive system, comprising:
an electric motor, comprising:
an outputting hollow motor shaft;
a pinion shaft bearing arrangement; and,
a differential, which is driven by means of the pinion shaft, which is driven by the electric motor, wherein the pinion shaft is arranged concentrically in the motor shaft; and the bearing assembly is tightly sealed and connected to a differential housing, which encloses the differential, by means of a sealing element.
